(19) United States
(12) Patent Application Publication
(10) Pub. No.: US 2011/0141346 A1
(43) Pub. Date: Jun. 16, 2011

(54) Camera Module and Manufacturing Method Thereof

(75) Inventor: Youngjun Ryu, Seoul (KR)

(73) Assignee: LG Innotek Co., Ltd., Seoul (KR)

(21) Appl. No.: 12/967,915

(22) Filed: Dec. 14, 2010

(30) Foreign Application Priority Data
Dec. 14, 2009 (KR) 10-2009-0124178

(51) Int. Cl. H04N 5/225; H01R 43/00

(52) U.S. Cl. 348/374; 29/825; 348/E05.024

(57) ABSTRACT

Disclosed herein are a camera module and a manufacturing method thereof, the camera module including a plurality of lenses, a substrate arranged at the lower part of the plurality of lenses, an infrared blocking agent formed on the upper surface of the substrate to block infrared light, and an image sensor positioned at the lower surface of the substrate to convert an optical image incident through the plurality of lenses into an electrical signal.

### CROSS-REFERENCE TO RELATED APPLICATION

This application claims the benefit under 35 U.S.C. §119 of Korean Application No. 10-2009-0124178, filed on Dec. 14, 2009, which is hereby incorporated by reference in its entirety.

### BACKGROUND OF THE DISCLOSURE

1. Field of the Invention

The present invention relates to a camera module mounted on portable terminals and a manufacturing method thereof.

2. Discussion of the Related Art

In recent years, demand in a small-size camera module for use in various kinds of multimedia fields such as a note-type personal computer, a camera phone, a smart device and a toy, and picture image devices such as a data terminal of a surveillance camera and a video tape recorder, has been increasing.

Especially, in the case of a mobile phone, a design is conceived of a factor having an enormous impact on sales, on account of this requiring a tiny-sized camera module.

The camera module manufactured using an image sensor chip such as a CCD and a CMOS, concentrates light through a lens on the image sensor chip, and converts an optical signal into an electrical signal to transfer images for displaying a subject on display media such as an LCD display device.

In general, a height of a camera module corresponds to a sum of a lens height (TTL, Through The Lens), an image sensor height and a thickness of a printed circuit board. Considering that a high lens TTL causes a better resolution of a camera, a sufficient lens TTL must be ensured at a certain camera module altitude in order for the camera module to be downsized and high-effective.

However, since in a conventional camera module, an image sensor is formed on the upper surface of a PCB (Printed Circuit Board), it is difficult to realize the miniaturization and high-fidelity of a camera module.

### BRIEF SUMMARY

The invention provides a miniaturization and high-performance-capable camera module and a manufacturing method thereof.

According to one aspect of the present invention, a camera module is provided, including a plurality of lenses, a substrate arranged at the lower part of said plurality of lenses, an infrared blocking agent formed on the upper surface of the substrate to block infrared light and an image sensor positioned at the lower surface of the substrate to convert an optical image incident through said plurality of lenses into an electrical signal.

According to another aspect of the present invention, a camera module manufacturing method is provided including an image sensor converting an incident optical image into an electrical signal. Such a method includes: coating an infrared blocking agent on the upper surface of a substrate positioned on the upper part of the image sensor for blocking infrared light; forming a first circuit pattern on the top of the infrared blocking agent using a metal composition; forming a via hole running through the lower surface and upper surface of the substrate; and sticking the image sensor into a lower surface of the substrate to electrically connect an upper surface of said image sensor to the upper surface of said substrate through the via hole.

An embodiment of the present invention applies a coating of the upper surface of a substrate with an infrared blocking agent, a separate IR filter is unnecessary over prior-art technologies, and one substrate performs a role as an IR filter and a printed circuit board simultaneously, capable of lowering a cost of a camera module.

Also, compared to prior-art technologies, an embodiment of the present invention can decrease the dimension of a camera module by a thickness for assignment to the image sensor using an image sensor accommodated in a space created owing to a solder ball formed height because there is no need to allocate a thickness of the camera module for the image sensor, thereby realizing the miniaturization and high-performance of a camera module.

In addition, an embodiment of the present invention can improve a process yield by electrically connecting an image sensor to a substrate by a bonding and thus not performing separate processes such as a die bonding and a wire bonding, leading to curtail of its manufacturing time.

### BRIEF DESCRIPTION OF THE DRAWINGS

FIG. 1 is a cross-sectional view of a camera module according to an embodiment of the present invention;

FIG. 2 is a flow diagram indicating a camera module manufacturing method according to an embodiment of the present invention; and

FIGS. 3a through 3i are diagrams indicating a manufacture process according to a flow diagram of FIG. 2.

### DETAILED DESCRIPTION

Since the present invention can be applied with various changes thereto and several types of embodiments, specific embodiments intend to be exemplified in the drawings and minutely described in the detailed description. However, it should not be appreciated in a limiting sense of limiting the present invention to a specific example but to include all the changes, equivalents and replacements which fall in the spirit and technical scope of the present invention.

While terms including ordinal numbers such as a first and a second may be used to describe various components, such components are not limited to the terms. The terms are used only for the purpose of distinguishing one component from other components.

For example, a second component may be named as a first component without departing from the scope of the present invention rights, and in a similar way, the first component may be renamed as the second component.

Stated that any component is “connected” or “conjunctive” to another component, it will be appreciated to be directly connected or conjunctive to the very another component or otherwise that there exists any component in the midst of them. On the other hand, stating that any component is “directly connected” or “directly conjunctive” to another component, it should be understood that any other component does not exist therebetween.

Terms used in the present application are only used to describe a specific embodiment, not in a sense of limiting the invention. A singular form includes a plural form, otherwise stated in a different way in the context. In this application, the terms such as “include” or “have” indicate that there exist a characteristic, a number, a step, an operation, a component, other things recited in the specification or a combination thereof, but it should not be understood to preclude the existence or addition of one or more other characteristics, numbers, operations, substances, components or a combination of thereof.

In the following, a camera module and a manufacturing method thereof according to an embodiment of the present invention will be described in detail referring to the attached drawings, but without regard to a drawing sign, an identical or corresponding component is assigned the same reference numeral and a redundant description regarding this will be omitted.

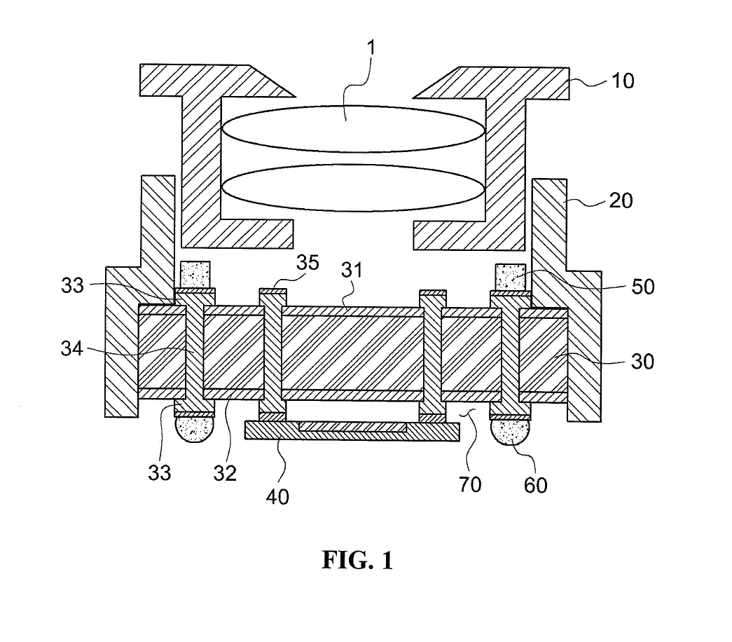

FIG. 1 is a cross-sectional diagram of a camera module according to an embodiment of the present invention.

As illustrated in FIG. 1, a camera module of the present invention includes a lens barrel 10, a holder 20, a substrate 30, and an image sensor 40.

The lens barrel 10 refers to a means for fixing and protecting a plurality of lenses 1, and the inner side of the lens barrel 10 includes a plurality of lenses 1 on which an optical image of a subject may be incident.

The inner-rim surface of the holder 20 faces an outside surrounding surface of the lens barrel 10 and the holder 20 also serves as a case protecting the substrate 30 and the image sensor 40.

The substrate 30 is formed of a glass substrate, the upper surface of the substrate 30 is coated with an infrared blocking agent 31 of Ir (iridium) composition capable of blocking infrared, and the lower surface of the substrate 30 is coated with an anti-reflection agent 32 of Ar (argon) composition for inhibiting the reflection of an optical image incident through the substrate 30. At this time, the infrared blocking agent 31 and the anti-reflection agent 32 is formed sufficiently thick not to be damaged by an etching solution in a formation course of a circuit pattern on the substrate 30.

In the present invention, the infrared blocking agent 31 is coated on the upper surface of the substrate 30, so that there is no need of a separate IR filter over a prior-art technology and one substrate 30 can carry out a mission of an IR filter and a printed circuit board simultaneously. For that reason, a unit cost of a camera module may be lowered.

Various circuit patterns 33 based on an applied device could be formed on the upper surface and the lower surface of the substrate 30, and in order to electrically connect an upper surface circuit pattern and a lower surface circuit pattern, the substrate 30 has a plurality of via holes 34 running through the upper surface and lower surface of the substrate 30.

A circuit pattern 33 is formed through an etching after depositing or sputtering a metal composition such as Cu on the upper surface and lower surface of the substrate 30.

And, a plurality of via holes 34 is formed in the substrate 30 which electrically connects an upper surface and a lower surface of the substrate 30, and device 50 such as a driver IC (Integrated Circuit) could be mounted on one side of the upper surface of the substrate 30. The device 50 could be any one of an active device and a passive device.

A solder ball 60 is formed on one side of the lower surface of the substrate 30, and is electrically connected to an outer part of the camera module to transmit an image signal outputted by the image sensor 40 to other media.

The image sensor 40 is accommodated in an image sensor accommodation part 70, that is, a space except for a solder ball 60 formed spaces under the lower surface of the substrate 30, and electrically connected by a flip chip bonding to the substrate 30. At this time, a depth of the image sensor accommodation part 70 can be changed by an elevation of the solder ball 60.

As such, in the present invention, since the image sensor 40 is accommodated in a space created due to an elevation of the solder ball 60, there is no need to assign a thickness of the camera module for the image sensor 40 over the prior art. Thus, by reducing a dimension of the camera module as a thickness as assigned to the image sensor 40, miniaturization and high-efficiency of a camera module can be realized.

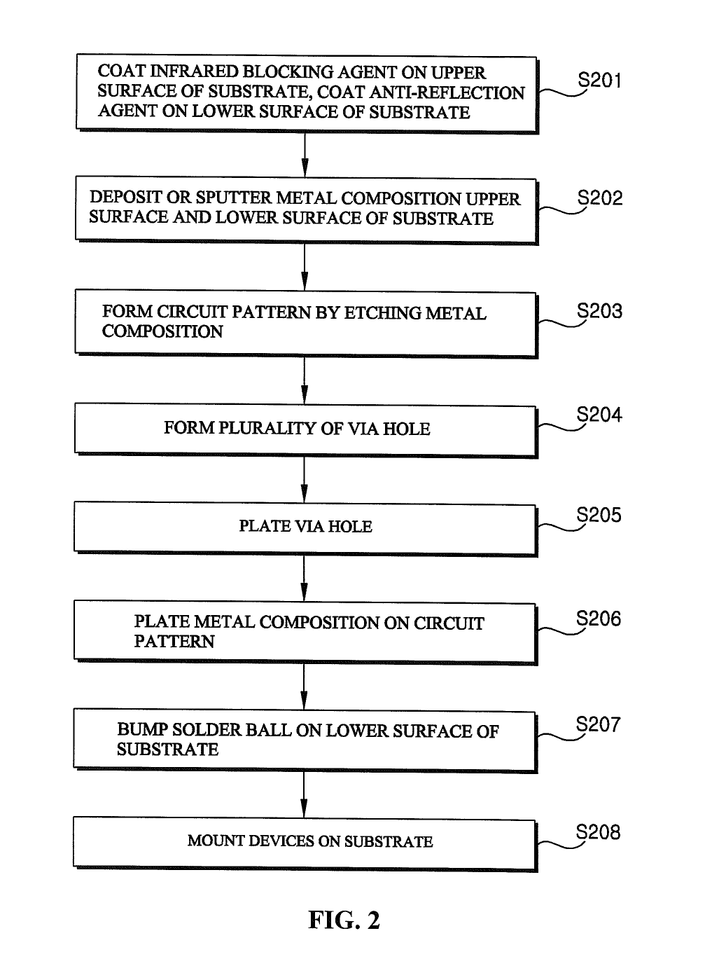

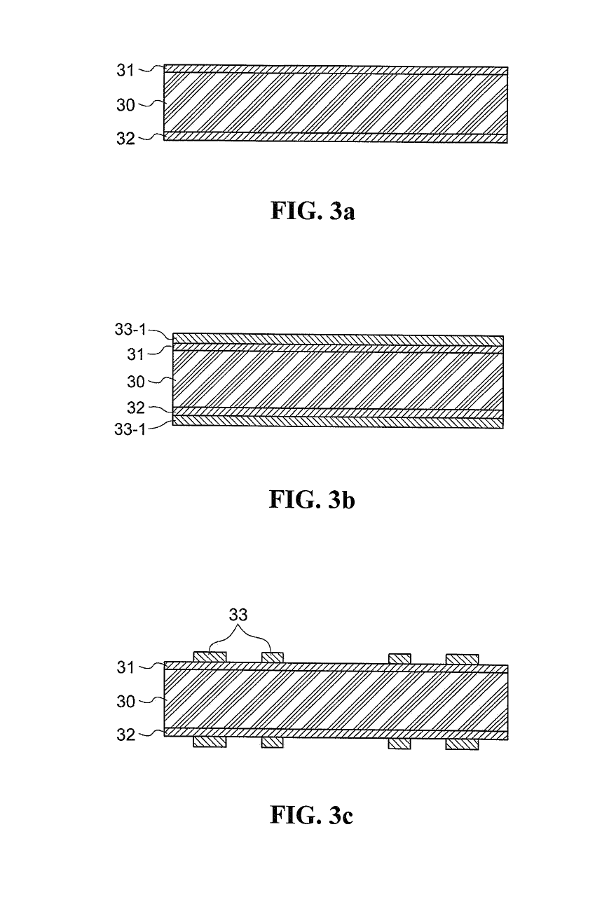

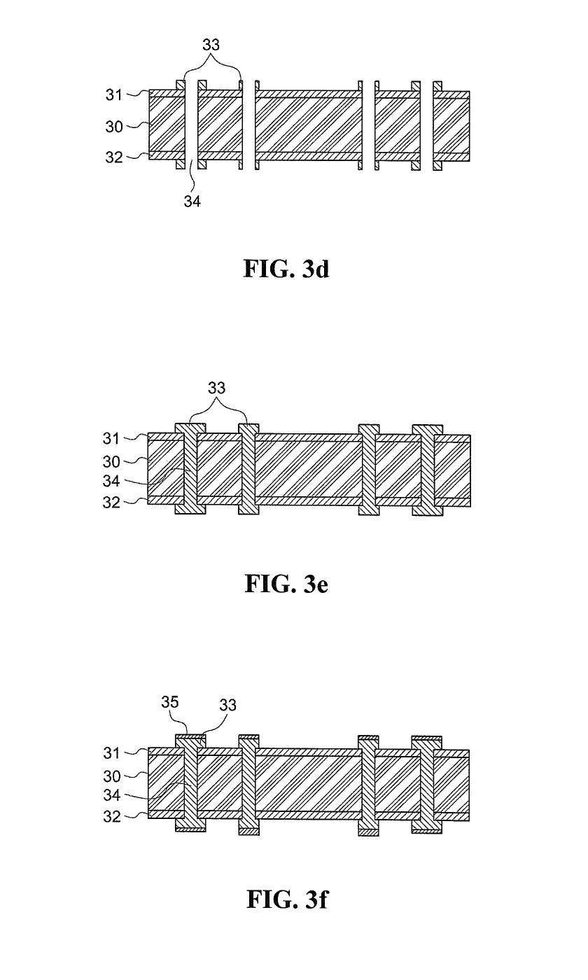

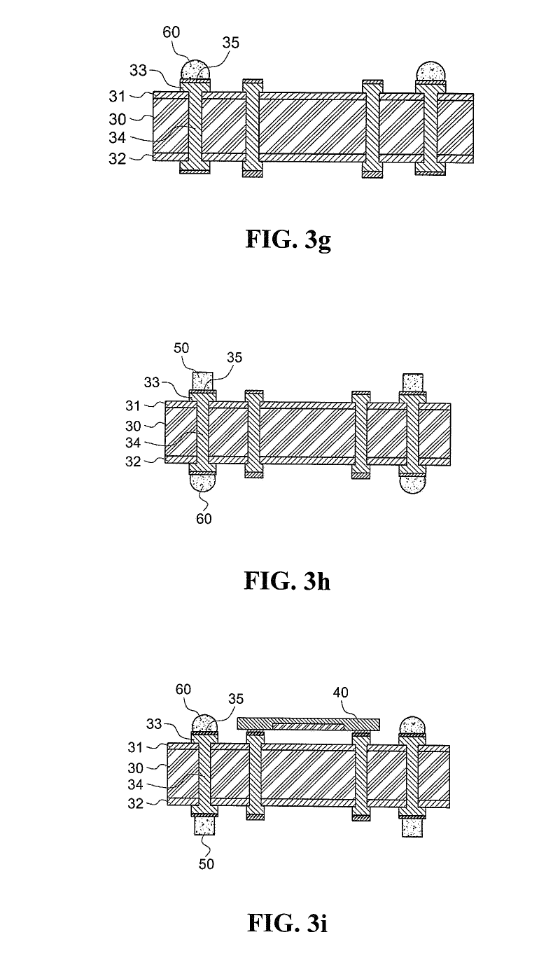

FIG. 2 is a flow diagram indicating a camera module manufacturing method according to an embodiment of the present invention, and FIGS. 3a through 3i are diagrams indicating a manufacture process according to a flow diagram of FIG. 2.

As illustrated in FIGS. 2 and 3a, an infrared blocking agent 31 of Ir composition is coated on an upper surface of the substrate 30 of glass material at first, an anti-reflecting agent 32 of Ar composition is coated on a lower surface of the substrate 30 (S201). At this time, the infrared block agent 31 and the anti-reflecting agent 32 are sufficiently thick so as not to be damaged by an etching solution in the course of forming a circuit pattern 33 on substrate 30.

As illustrated in FIG. 3b, a metal composition 33-1 such as Cu is deposited or sputtered on the upper surface and lower surface of the substrate 30 (S202).

And, as illustrated in FIG. 3c, the metal composition is etched out using an etching solution so that a desired circuit pattern 33 is only left (S203).

In the present invention, the etching solution refers to a solution solely etching metal compositions, thus a solution unable to etch the infrared blocking agent 31 and the anti-reflection agent 32.

As illustrated in FIG. 3d, in order to connect an upper surface circuit pattern 33 and a lower surface circuit pattern 33, a plurality of via holes 34 are formed using a laser drill (S204).

As illustrated in FIG. 3e, a via hole 34 is electroless plated using metal compositions such as Cu (S205).

After the via hole 34 is plated, metal compositions 35 such as Ni or Au are plated on the circuit pattern 33 as shown in FIG. 3f (S206).

Next, as illustrated in FIG. 3g, a lower surface of the substrate 30 is bumped with a solder ball 60 (S207).

As illustrated in FIG. 3h, devices 50 such as a driver IC is mounted on one side of the circuit pattern 33 on the upper surface of the substrate 30 using SMT (Surface Mount Technology) (S208).

In the next phase, as illustrated in FIG. 3i, an image sensor accommodation part 70 created due to an elevation of the solder ball 60 in the lower surface of the substrate 30 accommodates the image sensor 40, which is electrically connected to the substrate 30 by means of a flip chip bonding (S209).

The flip chip bonding may be one process of an ACF (Anisotropic Conductive Film), an NCF (Non Conductive Film), an ACP (Anisotropic Conductive Paste), and an NCP (Non Conductive Paste).

Lastly, when the substrate 30 and the image sensor 40 formed by a process of FIGS. 3a through 3i are mounted on the holder 20, a camera module according to an embodiment of the present invention is manufactured as shown in FIG. 1.

The present invention electrically connects the image sensor 40 and the substrate 30 by means of a flip chip bonding, thereby shortening manufacturing time and improving process efficiency because of not performing separate processes such as a die bonding and a wire bonding.

While embodiments of the present invention have been described in the previous section, it would be understood to those skilled in the art that an embodiment employing various changes and improvements also can be made thereof within the scope of the present invention using basic concepts of the present invention defined by the following claims, not limited to the above embodiment.

What is claimed is:

1. A camera module, comprising:
a plurality of lenses;
a substrate arranged at the lower part of the plurality of lenses;
an infrared blocking agent formed on the upper surface of the substrate to block infrared light; and
an image sensor positioned at the lower surface of the substrate to convert an optical image incident through the plurality of lenses into an electrical signal.

2. The camera module according to claim 1, further comprising an anti-reflection agent formed on the lower surface of the substrate to inhibit the reflection of the optical image incident through the substrate.

3. The camera module according to claim 2, wherein a circuit pattern is formed on the upper surface of the anti-reflection agent of the substrate, and a solder ball being formed in the circuit pattern to transmit an electrical signal of the image sensor to outside.

4. The camera module according to claim 1, wherein a circuit pattern is formed on upper surface of the infrared blocking agent of the substrate, and the device being mounted in the circuit pattern.

5. The camera module according to claim 1, wherein via holes are formed in the substrate, electrically connecting the upper surface and lower surface of the substrate, and the upper surface of the substrate and the image sensor being electrically connected by means of the via holes.

6. The camera module according to claim 1, wherein the substrate is made of glass material.

7. A camera module manufacturing method comprising an image sensor operable to convert an incident optical image into an electrical signal, comprising the steps:
(a) coating an infrared blocking agent on the upper surface of a substrate positioned in the upper part of the image sensor for blocking infrared light;
(b) forming a first circuit pattern on the top of the infrared blocking agent using a metal composition;
(c) forming via holes running through the lower surface and upper surface of the substrate; and
(d) sticking the image sensor into a lower surface of the substrate to electrically connect an upper surface of the image sensor to the upper surface of the substrate through the via holes.

8. The camera module manufacturing method according to claim 7, wherein after the step (a), further including the step forming an anti-reflection agent on the lower surface of the substrate to inhibit the reflection of an optical image incident through the substrate.

9. The camera module manufacturing method according to 8, wherein after the step (b), further including the steps:
forming a second circuit pattern on the anti-reflection agent using a metal composition; and
forming a solder ball at a portion of the second circuit pattern transmitting an electrical signal of the image sensor to outside.

10. The camera module manufacturing method according to 7, wherein after the step (c), further including the step mounting devices on the first circuit pattern.

11. The camera module manufacturing method according claim 7, wherein the substrate is made of glass material.

12. The camera module according to claim 2, wherein the substrate is made of glass material.

13. The camera module according to claim 3, wherein the substrate is made of glass material.

14. The camera module according to claim 4, wherein the substrate is made of glass material.

15. The camera module according to claim 5, wherein the substrate is made of glass material.

16. The camera module manufacturing method according claim 8, wherein the substrate is made of glass material.

17. The camera module manufacturing method according claim 9, wherein the substrate is made of glass material.

18. The camera module manufacturing method according claim 10, wherein the substrate is made of glass material.
